(19) United States
(12) Patent Application Publication
(10) Pub. No.: US 2018/0034154 A1
(43) Pub. Date: Feb. 1, 2018

(54) ANTENNA AND COMMUNICATION DEVICE

(71) Applicant: TOKYO COSMOS ELECTRIC CO., LTD., Kanagawa (JP)

(72) Inventor: Kyouhei OZAWA, Kanagawa (JP)

(73) Assignee: TOKYO COSMOS ELECTRIC CO., LTD., Kanagawa (JP)

(21) Appl. No.: 15/551,790

(22) PCT Filed: Feb. 19, 2015
(86) PCT No.: PCT/JP2015/000793

§ 371 Date: Aug. 17, 2017

(51) Int. Cl. H01Q 7/00; H01Q 1/38

(52) U.S. Cl. CPC H01Q 7/00; H01Q 1/38

(57) ABSTRACT

Provided are: an antenna, wherein size can be easily reduced, gain is high, manufacturing cost can be suppressed, and furthermore, disposition direction can be easily fixed; and a communication device. An antenna (3) is to be attached to a wireless module (2) that is provided with: a substrate (4); a wireless circuit fixed to the substrate (4); and a coaxial connector (8), which is fixed to the substrate (4), and is connected to the wireless circuit. The antenna is provided with: a substrate (5); a conductor (6) formed on one surface of the substrate (5); and a coaxial connector (9), which is fixed to the substrate (5) in a state of being connected to the conductor (6), and is removably coupled to the coaxial connector (8). In a state wherein the coaxial connector (8) and the coaxial connector (9) are coupled to each other, the substrate (5) is fixed in parallel to the substrate (4).

### TECHNICAL FIELD

The present invention relates to an antenna and a communication device including the antenna.

### BACKGROUND ART

Pattern antennas are widely used in which a planar antenna element is formed on a substrate, and power is supplied to the antenna element through a coaxial cable so that the antenna element functions as an antenna.

Patent Literature (hereinafter, referred to as “PTL”) 1, for example, discloses an antenna composed of three components: a substrate having antenna elements formed on its surface; a coaxial cable; and an RF connector which is attached to an end of the coaxial cable for coupling with a receiving circuit.

In this antenna, inner and outer conductors of the coaxial cable are soldered to the antenna elements, respectively. A signal received at the antenna element is then transmitted to the receiving circuit via the coaxial cable.

### CITATION LIST

### Patent Literature

### PTL 1

Japanese Patent Application Laid-Open No. H10-313207

### SUMMARY OF INVENTION

### Technical Problem

With the related art disclosed in PTL 1, however, signals are transmitted via the coaxial cable and this leads to difficulty in size reduction of a communication device, lower gain, and increased manufacturing costs. Further, since the antenna and the receiving circuit are connected to each other by a bendable coaxial cable, another member is required for fixing the installation direction of the antenna.

The present invention has been made in view of the aforementioned problem and aims to provide: an antenna which enables easy size reduction, higher gain, lower manufacturing costs, and easy fixing of the installation direction; and a communication device.

### Solution to Problem

An antenna according to the present invention is an antenna to be attached to a radio module including a first substrate, a radio circuit to be fixed to the first substrate, and a first coaxial connector to be fixed to the first substrate and to be connected to the radio circuit, the antenna including: a second substrate; a conductor formed on one surface side of the second substrate; and a second coaxial connector to be fixed to the second substrate in a state where the second coaxial connector is connected to the conductor, and to be detachably coupled to the first coaxial connector, in which the second substrate is fixed parallel to the first substrate in a state where the second coaxial connector is coupled to the first coaxial connector.

A communication device according to the present invention includes the antenna and the radio module.

### Advantageous Effects of Invention

According to the present invention, it is possible to provide: an antenna which enables easy size reduction, higher gain, lower manufacturing costs, and easy fixing of the installation direction; and a communication device.

### BRIEF DESCRIPTION OF DRAWINGS

FIG. 1 is a diagram illustrating an exemplary configuration of a communication device according to an embodiment of the present invention;

FIG. 2 is a diagram illustrating an exemplary configuration of a radio module forming the communication device;

FIG. 3 is a diagram illustrating an exemplary configuration of an antenna forming the communication device;

FIG. 4 is a plan view illustrating a coaxial connector of the antenna;

FIG. 5 is a bottom view illustrating the coaxial connector of the antenna;

FIG. 6 is a side view illustrating the coaxial connector of the antenna; and

FIG. 7 is a diagram illustrating radiation patterns of the communication device.

### DESCRIPTION OF EMBODIMENTS

In the following, an embodiment of the present invention is described in detail with reference to the accompanying drawings.

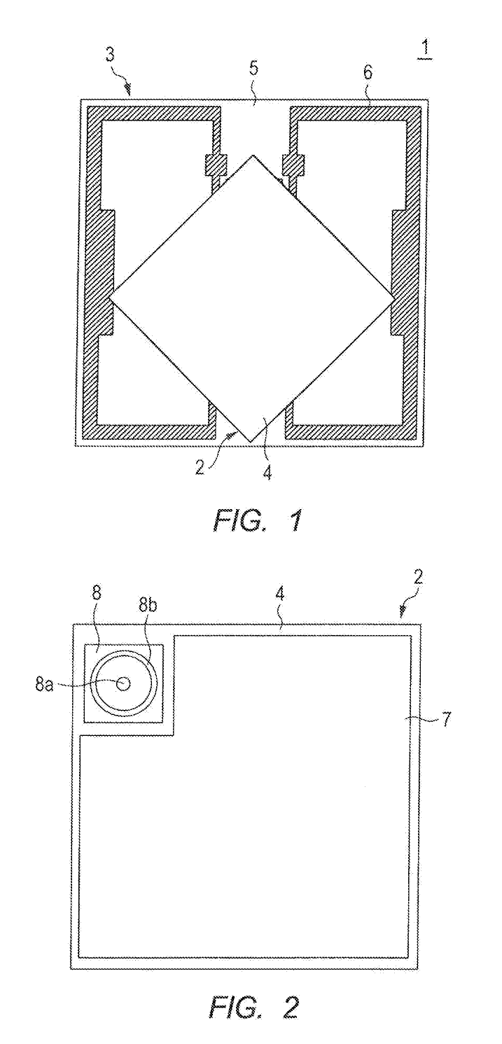

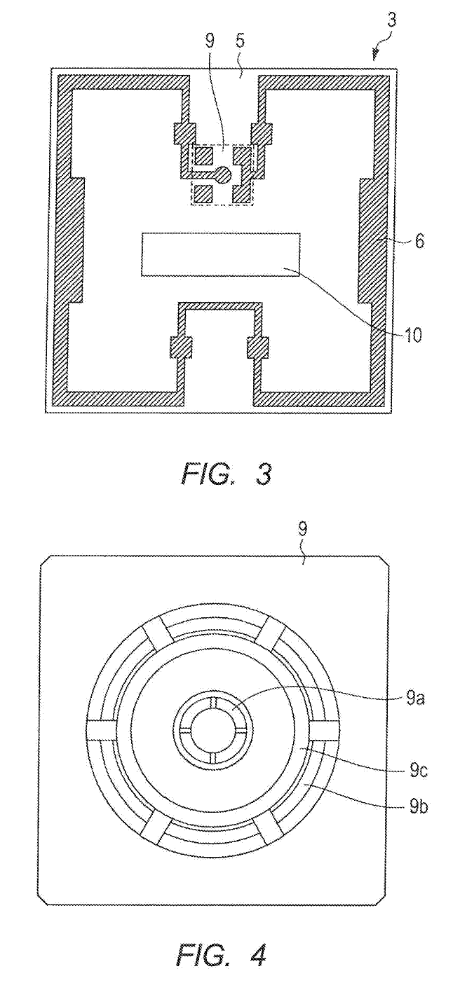

FIG. 1 is a diagram illustrating an exemplary configuration of communication device 1 according to the embodiment of the present invention. FIG. 2 is a diagram illustrating an exemplary configuration of radio module 2 forming communication device 1. FIG. 3 is a diagram illustrating an exemplary configuration of antenna 3 forming communication device 1.

As shown in FIG. 1, communication device 1 includes radio module 2 and antenna 3. Radio module 2 performs radio communication with other communication devices by transmitting and receiving radio waves via antenna 3.

As shown in FIG. 2, radio module 2 includes: substrate 4; electronic component 7 on which a radio circuit, a microcomputer, a memory, a peripheral circuit, and the like are mounted; coaxial connector 8 for coupling radio module 2 and antenna 3; and a battery holder (not shown) for accommodating a battery such as a coin type battery that supplies power to electronic component 7.

Coaxial connector 8 is a male connector which includes inner conductor 8a having a pin-shaped portion adopted to contact coaxial connector 9 to be described later and outer conductor 8b having a cylindrical portion adopted to contact coaxial connector 9.

As shown in FIG. 3, antenna 3 includes substrate 5, conductor 6 formed on the surface of substrate 5, coaxial connector 9, and double-sided adhesive tape 10. Conductor 6 forms a loop-like pattern, and the two ends of conductor 6 face each other. By supplying power to the two ends, antenna 3 functions as a loop antenna.

Also, female coaxial connector 9 adopted to couple to coaxial connector 8 of radio module 2 is provided in an area where the two ends of conductor 6 are disposed, and coaxial connector 9 is fixed to substrate 5 in a state of being connected to conductor 6.

In FIG. 3, coaxial connector 9 is indicated by a dotted line, where the detailed shape of coaxial connector 9 is not shown. The shape and the like of coaxial connector 9 will be described later in detail with reference to FIGS. 4 to 6.

Coaxial connector 8 and coaxial connector 9 are detachably coupled. When coaxial connector 8 and coaxial connector 9 are coupled, substrate 4 of radio module 2 and substrate 5 of antenna 3 are fixed in parallel.

In the manner described above, detachably coupling coaxial connector 8 and coaxial connector 9 allows an antenna having a conductor pattern different from that of antenna 3 to be used depending on the purpose of use or the use environment, and enables adjusting the directivity and the gain. For example, an antenna having a conductor pattern such as that of a dipole antenna can be used.

Further, since antenna 3 can be fixed to radio module 2, the radiation direction of radio waves can be set to a certain direction, and another member for fixing the installation direction of antenna 3 is unnecessary, which allows for size reduction of communication device 1.

Moreover, double-sided adhesive tape 10, a separate fixing member from coaxial connectors 8 and 9, is used for coupling substrates 4 and 5. Thereby, substrates 4 and 5 are more firmly fixed to each other. Note that it is not always necessary to use double-sided adhesive tape 10, and substrates 4 and 5 may be fixed to each other only by coupling coaxial connectors 8 and 9.

Alternatively, instead of double-sided adhesive tape 10, substrates 4 and 5 may be fixed to each other by a screw, or substrates 4 and 5 may be fixed to each other by accommodating radio module 2 and antenna 3 in a case. Further, substrates 4 and 5 may be fixed by a fixing member other than double-sided adhesive tape 10, a screw, or a case.

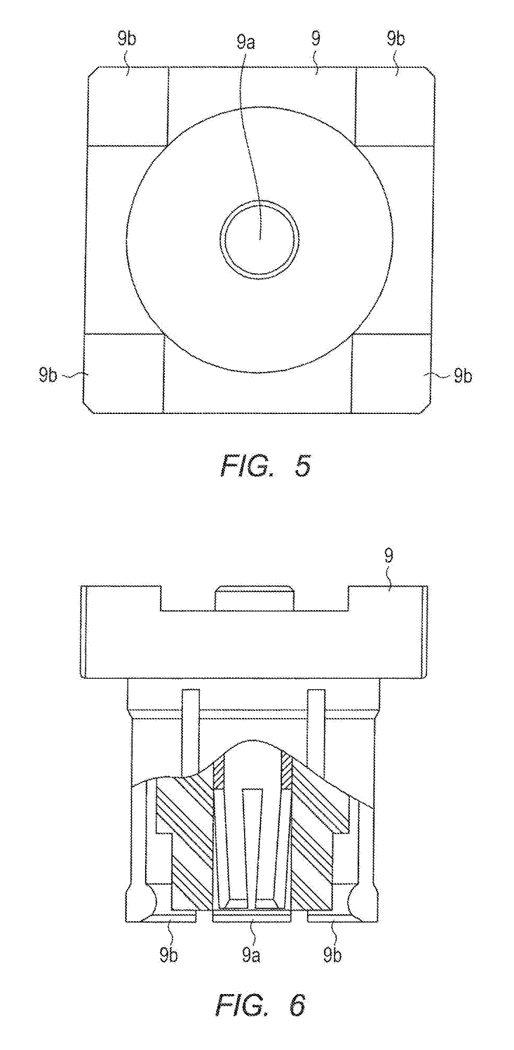

Next, the shape and the like of coaxial connector 9 of antenna 3 will be described in detail. FIG. 4 is a plan view of coaxial connector 9, FIG. 5 is a bottom view of coaxial connector 9, and FIG. 6 is a side view of coaxial connector 9. Note that a part of FIG. 6 is a cross-sectional view to illustrate the inside of coaxial connector 9.

As shown in FIG. 4, coaxial connector 9 includes inner conductor 9a having a hole through which a pin-shaped portion of inner conductor 8a of coaxial connector 8 is to be inserted; outer conductor 9b adopted to contact the cylindrical portion of outer conductor 8b of coaxial connector 8; and groove 9c for allowing the cylindrical portion of outer conductor 8b to enter and causing outer conductor 8b and outer conductor 9b to contact with each other.

As shown in FIGS. 5 and 6, inner conductor 9a extends to the bottom surface of coaxial connector 9 and is connected to the end portion of conductor 6 at the center of coaxial connector 9 shown in FIG. 3. On the other hand, outer conductor 9b also extends to the bottom surface of coaxial connector 9 and is connected to the end portion of conductor 6 at the corner of coaxial connector 9 shown in FIG. 3.

Connecting coaxial connector 9 and conductor 6 in the manner described above and supplying power from radio module 2 to the end portion of conductor 6 allows antenna 3 to function as a loop-antenna.

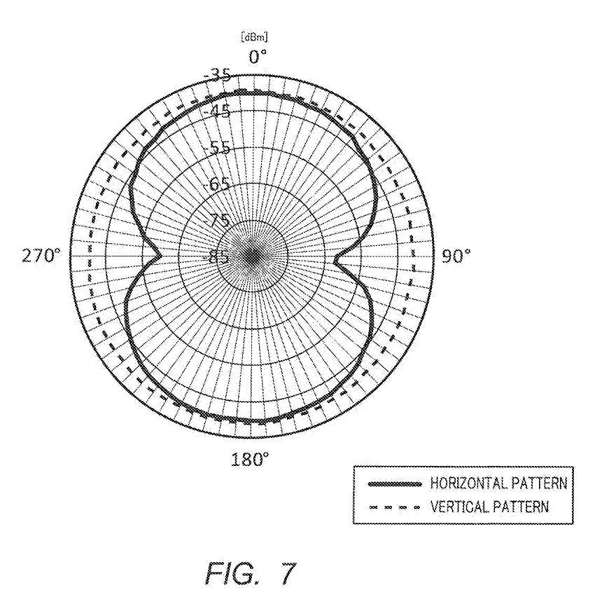

FIG. 7 is a diagram illustrating a radiation pattern when communication device 1 shown in FIG. 1 is disposed such that the normal direction of substrates 4 and 5 is in the horizontal direction. The solid line in FIG. 7 indicates the horizontal radiation pattern of communication device 1, and the dotted line in FIG. 7 indicates the vertical radiation pattern of communication device 1.

As shown in FIG. 7, the directivity of communication device 1 is similar to the directivity of widely used dipole antennas. As described above, since the general characteristics can be obtained in communication device 1, handling of the communication device 1 becomes easy.

Further, in communication device 1, the radio module and the antenna are not connected using a coaxial cable but are connected by coaxial connectors 8 and 9 unlike the related art, so that communication device 1 can be further reduced in size and the manufacturing costs of communication device 1 can be reduced as well.

Furthermore, in communication device 1, since no coaxial cable is used for coupling radio module 2 and antenna 3, cable loss by the coaxial cable is eliminated, and communication device 1 with higher gain can be obtained.

### INDUSTRIAL APPLICABILITY

The present invention is suitable for use in an antenna and a communication device.

### REFERENCE SIGNS LIST

1 Communication Device
2 Radio Module
3 Antenna
4, 5 Substrate
6 Conductor
7 Electronic Component
8, 9 Coaxial Connector
8a, 9a Inner Conductor
8b, 9b Outer Conductor
9c Groove
10 Double-Sided Adhesive Tape

1. An antenna to be attached to a radio module including a first substrate, a radio circuit to be fixed to the first substrate, and a first coaxial connector to be fixed to the first substrate and to be connected to the radio circuit, the antenna comprising:
a second substrate;
a conductor formed on one surface side of the second substrate; and
a second coaxial connector to be fixed to the second substrate in a state where the second coaxial connector is connected to the conductor, and to be detachably coupled to the first coaxial connector,
wherein the second substrate is fixed parallel to the first substrate in a state where the second coaxial connector is coupled to the first coaxial connector.

2. The antenna according to claim 1, wherein the conductor is formed in a loop shape.

3. A communication device comprising the antenna according to claim 1 and the radio module according to claim 1.

4. The communication device according to claim 3, further comprising a fixing member for fixing the first substrate and the second substrate, wherein the fixing member is separate from the first coaxial connector and the second coaxial connector.

5. The communication device according to claim 4, wherein the fixing member is a double-sided adhesive tape.

6. The communication device according to claim 4, wherein the fixing member is a screw.

7. The communication device according to claim 4, wherein the fixing member is a case for accommodating the radio module and the antenna.
